(19) United States
(12) Patent Application Publication
(10) Pub. No.: US 2018/0054842 A1
(43) Pub. Date: Feb. 22, 2018

(54) FINE TIMING MEASUREMENTS PROTOCOL IN ESTABLISHING TUNNELED DIRECT LINK SETUP CONNECTION

(71) Applicant: QUALCOMM Incorporated, San Diego, CA (US)

(72) Inventors: Manohar Kandagadla, Hyderabad (IN); Naresh Kumar Varada, Hyderabad (IN); Venkatarao Reddy Buddala, Hyderabad (IN)

(21) Appl. No.: 15/243,415

(22) Filed: Aug. 22, 2016

(51) Int. Cl. H04W 76/02; H04W 64/00; H04B 17/318; H04L 12/46; H04L 27/26

(52) U.S. Cl. CPC H04W 76/023; H04W 64/00; H04W 84/12; H04L 12/4633; H04L 27/2665; H04B 17/318

(57) ABSTRACT

Methods, systems, and devices for wireless communication are described. Wireless stations (STAs) may have traffic to exchange between one another. Through establishing a direct connection with another STA, communications may flow directly from one STA to the other STA, without occupying resources of the network at the access point (AP). This may make the network more efficient, as the AP may direct those unused resources to other communication needs. When establishing a direct connection between STAs, the STAs may be unable or have difficulty determining a signal strength because different signals may be based on different transmission powers. In some examples, it may be beneficial to use a ranging frame, such as a fine timing measurement (FTM) frame, for determining a signal strength between two STAs.

### BACKGROUND

The following relates generally to wireless communication, and more specifically to fine timing measurement (FTM) protocol in establishing a tunneled direct link setup (TDLS) connection.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include at least one access point (AP) that may communicate with at least one station (STA) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

At times it may be beneficial for STAs to establish a direct connection between one another. For example, by communicating directly from one STA to another STA, such as without relaying the information through another device (e.g., an AP), a wireless communications system may offload some data from the network, thereby saving resources and overhead for other devices using the network (e.g., an AP). However, difficulties may arise when determining appropriate candidates for direct connections between STAs, for example, due to inconsistencies in determining whether adequate communication parameters are present for a direct connection. As such, it is desirable to determine a more consistent way of establishing a direct connection between STAs.

### SUMMARY

The described techniques relate to improved methods, systems, devices, or apparatuses that support FTM protocol in establishing a TDLS connection. The present disclosure relates to direct connections between mobile devices operating on the same network (e.g., a WLAN). In some examples, the direct connections may include TDLS connections. To establish a direct connection between two devices, such as two stations (STA), both devices need to discover each other. The decision to establish a TDLS connection may be based on the traffic between the two devices and/or the signal strength, such as being based on a received signal strength indicator (RSSI). However, the RSSI may depend on the transmission power, which may vary between frames because the previously received packets may have been transmitted at a different rate and/or with different power. Similarly, a mobile device may receive different signal strengths even though both mobile devices remain stationary.

Other methods may perceive a weak signal strength as prohibitive to establishing a TDLS, or a direct connection even though the signal may have been purposefully transmitted with low signal strength. As such, a TDLS connection may be avoided unnecessarily. Similarly, at times a TDLS connection may be triggered when there is no need to trigger a TDLS connection.

These issues may be avoided or reduced if ranging techniques are introduced in establishing a connection (e.g., a TDLS connection). Specifically, ranging techniques may provide an accurate measurement of distance between two devices. In some cases, timing measurement frames may be used by compatible devices to determine a range. The timing measurement frames may, in some examples, be transmitted directly from one mobile device to another mobile device. Additionally, a new technique added in 802.11REV-mc called FTMs increases timestamp resolution, among other advantages, which better enables establishing these connection. As such, FTM frames may be exchanged between mobile devices to help determine whether to establish a TDLS connection.

A method of wireless communication is described. The method may include receiving, at a first station (STA) associated with a first network, ranging frames from a second STA associated with the first network, determining a signal strength based at least in part on the received ranging frames, and establishing a direct connection between the first STA and the second STA based at least in part on the determined signal strength.

An apparatus for wireless communication is described. The apparatus may include means for receiving, at a first station (STA) associated with a first network, ranging frames from a second STA associated with the first network, means for determining a signal strength based at least in part on the received ranging frames, and means for establishing a direct connection between the first STA and the second STA based at least in part on the determined signal strength.

Another apparatus for wireless communication is described. The apparatus may include a processor, memory in electronic communication with the processor, and instructions stored in the memory. The instructions may be operable to cause the processor to receive, at a first station (STA) associated with a first network, ranging frames from a second STA associated with the first network, determine a signal strength based at least in part on the received ranging frames, and establish a direct connection between the first STA and the second STA based at least in part on the determined signal strength.

Some examples of the method and apparatus described above may further include processes, features, means, or instructions for receiving, at the first STA, a traffic indication, wherein establishing the direct connection may be based at least in part on the determined signal strength and the received traffic indication.

In some examples of the method and apparatus described above, the traffic indication indicates a presence of data to be transmitted between the first STA and the second STA.

In some examples of the method and apparatus described above, at least the first STA or the second STA or a combination thereof may be associated with an access point (AP) on the first network while the direct connection may be established.

In some examples of the method and apparatus described above, the ranging frames may be transmitted using a same rate, or a same transmission power, or a combination thereof.

In some examples of the method and apparatus described above, the determined signal strength may be based at least in part on a number of received signal strength indicator (RSSI) values.

In some examples of the method and apparatus described above, determining the signal strength comprises determining an average of the number of RSSI values associated with the received ranging frames.

Some examples of the method and apparatus described above may further include processes, features, means, or instructions for determining that the second STA may be in motion relative to the first STA based at least in part on the number of RSSI values.

In some examples of the method and apparatus described above, the ranging frames comprise fine timing measurement (FTM) frames.

In some examples of the method and apparatus described above, the FTM frames may be transmitted during a burst duration having a variable length.

In some examples of the method and apparatus described above, the first network comprises a wireless local area network (WLAN).

In some examples of the method and apparatus described above, the direct connection between the first STA and the second STA comprises a tunneled direct link setup (TDLS).

### BRIEF DESCRIPTION OF THE DRAWINGS

FIG. 1 illustrates an example of a system for wireless communication that supports FTM protocol in establishing a TDLS connection in accordance with aspects of the present disclosure.

FIG. 2 illustrates an example of a wireless communications system that supports FTM protocol in establishing a TDLS connection in accordance with aspects of the present disclosure.

FIG. 3 illustrates an example of a process flow that supports FTM protocol in establishing a TDLS connection in accordance with aspects of the present disclosure.

FIGS. 4 through 6 show block diagrams of a device that supports FTM protocol in establishing a TDLS connection in accordance with aspects of the present disclosure.

FIG. 7 illustrates a block diagram of a system including a STA that supports FTM protocol in establishing a TDLS connection in accordance with aspects of the present disclosure.

FIGS. 8 through 10 illustrate methods for FTM protocol in establishing a TDLS connection in accordance with aspects of the present disclosure.

### DETAILED DESCRIPTION

The present disclosure relates to direct connections between mobile devices operating on the same WLAN. In some examples, the direct connections may include TDLS connections. To establish a direct connection between two devices, such as two STAs, the devices need to discover each other. The decision to establish a TDLS connection may be based on the traffic between the two devices and/or the signal strength, such as being based on a received signal strength indicator (RSSI). However, the RSSI may depend on the transmission power, which may vary. For example, transmission power may vary between frames because the previously received packets may have been transmitted at a different rate and/or with different power. Similarly, a mobile device may receive different signal strengths associated with different transmissions even though the mobile devices remain stationary. Further, temporary loss of line-of-sight (LOS) (e.g., due to an intermittent obstruction), may cause a high variance in the received signal strength. All of these situations highlight problems with connections (e.g., TDLS) decisions based on less-effective data or parameters.

Other methods may perceive a weak signal strength as prohibitive to establishing a TDLS, or a direct connection even though the signal may have been purposefully transmitted with low signal strength. As such, a TDLS connection may be avoided unnecessarily. Similarly, at times a TDLS connection may be triggered when there is no need to trigger a TDLS connection.

These issues may be avoided or reduced if ranging techniques are introduced in establishing a connection (e.g., a TDLS connection). Specifically, ranging techniques may provide an accurate measurement of distance between two devices. In some cases, timing measurement frames may be used by compatible devices to determine a range. The timing measurement frames may, in some examples, be transmitted directly from one mobile device to another mobile device. Additionally, a new technique added in 802.11REV-mc called FTMs increases timestamp resolution, among other advantages, which better enables establishing these connection. As such, FTM frames may be exchanged between mobile devices to help determine whether to establish a TDLS connection. FTM frames may be exchanged at a certain burst duration, which may be controllable. For example, the burst duration may be as low as 250 μs or as high as 128 ms.

Each FTM frame may have a corresponding RSSI. Generally, if the burst duration is 4 ms or lower, four or more FTM frames may be exchanged between mobile devices. As such, multiple FTM frames may be considered, such as by averaging the FTM frame RSSI values when determining a range or signal strength. By using multiple FTM frames a more accurate RSSI value may be determined. Further, all FTM frames may be transmitted using the same rate and/or the same power. Therefore, the RSSI of a single FTM frame may be more accurate or reliable than the RSSI used in other methods. In some examples, a variance in RSSI between FTM frames may provide further information, such as whether the device is stationary or mobile. By using a number of FTM frames for signal strength measurements, a more reliable RSSI may be determined thereby leading to more accurate decisions regarding the establishment of a TDLS connection.

Aspects of the disclosure are initially described in the context of a wireless communications system. Aspects of the disclosure are further illustrated in a wireless communications subsystem and a process flow diagram. In addition, aspects of the disclosure are further illustrated by and described with reference to apparatus diagrams, system diagrams, and flowcharts that relate to FTM protocol in establishing a TDLS connection

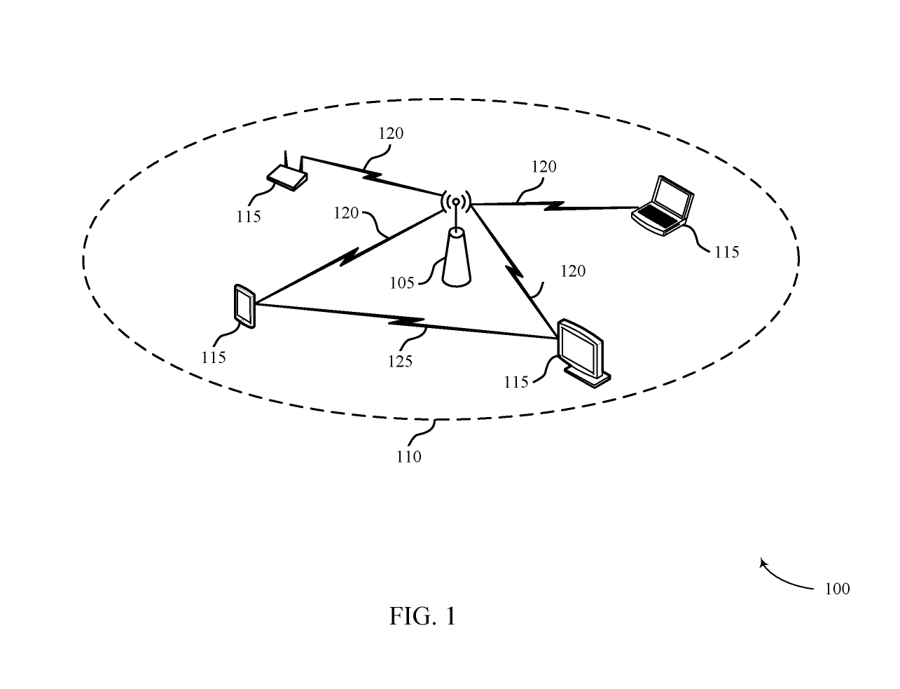

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a basic service set (BSS) or an extended service set (ESS). The various STAs 115 in the network are able to communicate with one another through the AP 105, such as by using wireless communication links 120. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS.

At times, STAs 115 may have traffic to exchange between one another. If a STA establishes a direct connection 125 with another STA 115, communications may flow directly from one STA 115 to the other STA 115, without occupying resources of the network at the AP 105. This may make the network more efficient, as the AP 105 may direct those unused resources towards other communication needs. When establishing a direct connection 125 between STAs, the STAs may have a difficult time determining a signal strength, as different signals may be transmitted using different transmission powers. Therefore it is beneficial to use a ranging frame, such as a FTM frame, for determining a signal strength between two STAs 115, since the ranging frames are transmitted using a set transmission power. As such, the determined signal strength may be more reliable and unsatisfactory direct connections between STAs may be avoided.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN network 100 may include APs 105 of different types (e.g., metropolitan area, home network, etc.), with varying and overlapping coverage areas 110. Two STAs 115 may also communicate directly via a direct wireless link, such as direct connection 125, regardless of whether both STAs 115 are in the same coverage area 110. Examples of direct wireless links 120 may include Wi-Fi Direct connections, Wi-Fi TDLS links, and other group connections. STAs 115 and APs 105 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN network 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier sense multiple access/collision avoidance (CSMA/CA)) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

Wireless communication links, such as direct connection 125, may also be established between STAs 115 in a configuration known as device to device (D2D) communications. At least one of a group of STAs 115 utilizing D2D communications may be within the coverage area 110 of a cell. Other STAs 115 in such a group may be outside the coverage area 110 of a cell, or otherwise unable to receive transmissions from a base station 105. In some cases, groups of STAs 115 communicating via D2D communications may utilize a one-to-many (1:M) system in which each STA 115 transmits to every other STA 115 in the group. In some cases, a base station 105 facilitates the scheduling of resources for D2D communications. In other cases, D2D communications are carried out independent of a base station 105 and, in some cases, may be based on FTM frames transmitted from a first STA to another STA that permit determinations regarding whether to establish a TDLS connection.

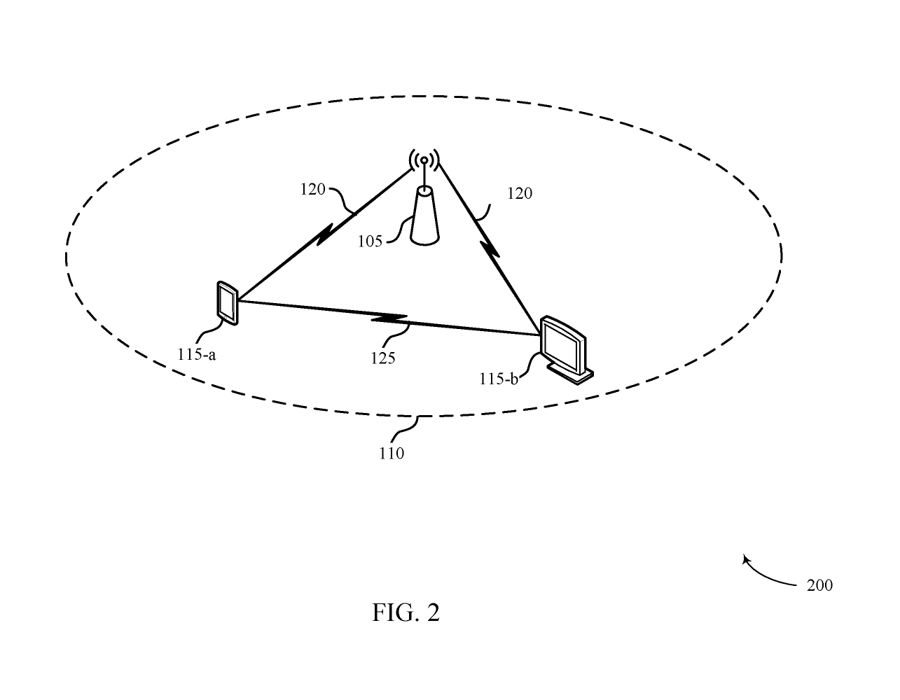

FIG. 2 illustrates an example of a wireless communications system 200 for FTM protocol in establishing a TDLS connection. Wireless communications system 200 may include AP 105, STA 115-a, and STA 115-b, which may be examples of the corresponding devices described with reference to FIG. 1. The examples described below with reference to a STA 115 may be performed by any number of devices, such as an AP 105, or a core network. Similarly, the examples described with reference to an AP 105 may be performed by any number of devices, such as a core network or a STA 115.

In some cases, AP 105 may be associated with a first network. The first network may be a wireless communications network, such as a WLAN network or a WWAN network. A number of STAs 115, such as STA 115-a and/or STA 115-b, may be associated with AP 105, or may otherwise exchange information with the AP 105. At times, there may be traffic, such as data or other signals, to be exchanged between STA 115-a and STA 115-b. In some cases, a STA 115, such as STA 115-a, may transmit data directed to another STA 115, such as STA 115-b, to the AP 105 using wireless communication link 120. The AP 105 may then transmit the data received from one STA 115, such as STA 115-a, to another STA 115, such as STA 115-b, using wireless communication link 120. However, this communication between the STAs 115 and through the AP 105 may be less efficient due to the use of resources and overhead at the AP 105. As such, it may be desirable to establish a direct connection 125, such as a D2D connection, between STAs 115.

In some cases, both, or one of STAs 115-a and 115-b are associated with or are otherwise exchanging data with AP 105 before and/or after establishing the direct connection 125. In some examples, STAs 115-a and/or 115-b are not associated with AP 105 before and/or after establishing the direct connection 125.

At times, establishing a direct connection 125 between STAs 115 may be based on a signal strength, such as an RSSI, another signal measurement parameter, or a some combination thereof. The signal strength may be a strength of a signal transmitted between the devices for which a direct connection 125 is to be established, such as STAs 115-a and 115-b. Therefore, when determining whether to establish a direct connection 125 between STAs 115, the STAs 115 may exchange information (e.g., signals).

The receiving STA 115, such as STA 115-b, may determine a signal strength of the signal received from the other STA 115, such as STA 115-a, which may be used to determine whether to establish a direct connection 125 with the STA 115. However, the receiving STA 115, such as STA 115-b, may be unaware of the transmission power and/or the transmission rate used by the transmitting STA 115, such as STA 115-a, when it transmits the signal. As such, the receiving STA 115 may incorrectly determine pathloss, or other factors contributing to the degradation of the signal between the STAs 115, and, consequently may improperly decide whether or not to establish a direct connection 125. For example, STA 115-a and STA 115-b may be located within a predetermined range to one another. In some examples, the predetermined range is used to describe a distance that would readily support a direct connection 125 with minimal pathloss or interference between the STAs 115. Yet in some cases, STA 115-b may determine not to establish a direct connection 125 with transmitting STA 115-a when the signal is not strong enough even though there is minimal pathloss, because the signal transmitted from STA 115-a was transmitted with a low signal power (i.e., a low signal power describing a signal with insufficient signal strength for establishing a direct connection 125 even if received without substantial loss).

Similarly, STA 115-a may transmit a signal using a stronger transmission power than would be expected for transmissions using a direct connection 125, which may cause STA 115-b to determine to establish a direct connection 125, even though subsequent transmissions over the direct connection 125 may be transmitted at a lower transmission power and, as such, may not be properly received. The result in either of these cases may be an incorrect decision as to whether or not to establish a direct connection 125.

To improve the signal strength determination and subsequently the decision whether or not to establish a direct connection 125, the transmitted signal may include ranging frames which may be used for determining a signal strength. In some cases, the ranging frames may include FTM frames. It should be noted that in some cases, the ranging frames, such as FTM frames which could be used for determining a location and/or a distance between STAs 115, are not used to determine a location and/or a distance. In some cases, these FTM frames are used for determining a signal strength. FTM frames may be used to determine a signal strength based on the transmission of the FTM frames using a known transmission power and/or rate. Further, FTM frames which were introduced in an amendment to the 802.11 standard are a standard signal and therefore their characteristics (such as transmission power and/or rate) are defined and/or constant in most cases. In some cases, ranging frames may be frames which are used by STAs 115 or APs 105 to determine a distance from another device, such as a STA 115 or AP 105.

In some examples, ranging frames may represent any frames which are transmitted at a known transmission power and/or transmitted at a known transmission rate. For example, FTM frames (among other contemplated examples) are transmitted at a set transmission power and at a set rate. As such, when a STA 115 receives a ranging frame from another STA 115 the receiving STA 115 has a priori knowledge of the transmission power and/or rate which allows the receiving STA 115 to more accurately determine the impact of pathloss, interference, and other factors detrimental to the propagation of the signal. By having a more accurate knowledge of the signal strength of the ranging frames as received at the receiving STA 115, a STA 115 may more effectively and more efficiently establish a direct connection with another STA 115.

In some examples, the signal may include additional information beneficial to determining a signal strength. For example, a signal may be transmitted with an indication of, or a value representative of, the transmit power and/or the transmit rate used to transmit the signal. Knowing the transmit power and/or the transmit rate may allow for more accurate determinations regarding the signal strength of the signal. As discussed above, by having a more accurate knowledge of the signal strength of the ranging frames as received at the receiving STA 115, a STA 115 may more effectively and efficiently establish a direct connection with another STA 115.

In some cases, the signal strength may be evaluated against a threshold, or a number of thresholds. In some cases, the threshold may be a signal strength threshold. For example, if the signal strength of a signal received at a STA 115, from another STA 115, exceeds a threshold, the STA 115 may determine to establish a direct connection 125. Whereas, if the signal strength of a signal received at a STA 115 does not exceed a threshold, the STA 115 may determine to not establish a direct connection 125.

In some examples, traffic between STAs 115 may be evaluated when determining whether to establish a direct connection 125. For example, if there is no traffic to be exchanged between STA 115-a and STA 115-b a direct connection 125 may not be established between the STAs 115 because it might not be necessary or beneficial. In contrast, if there is a large amount of traffic to be exchanged between STA 115-a and STA 115-b, it may be beneficial to the wireless communication system 200 for the STAs 115 to establish a direct connection 125. In some cases, at least one signal strength threshold may be variable based on the amount of traffic to be exchanged between STAs 115. For example, when more traffic is to be exchanged between STAs 115-a and 115-b, the signal strength threshold may be lowered, which may result in the STAs 115-a and 115-b being more likely to establish a direct connection 125.

In some examples, traffic between STAs 115, such as STA 115-a and STA 115-b, may be evaluated based on at least one traffic indication. In some cases, the traffic indication may represent or indicate the presence of data to be exchanged between STA 115-a and STA 115-b. In some cases, the traffic indication may indicate whether or not there is data to be transmitted. For example, the traffic indication may be a bit or a number of bits transmitted from the transmitting STA 115-a to the receiving STA 115-b or to the AP 105 (which may in some cases then transmit the traffic indication and/or another indication to the receiving STA 115-b).

In some examples, the traffic indication may represent the amount of data to be exchanged between STAs 115. For example, the traffic indication may be a value, where a value above a predetermined threshold may represent more data to be exchanged and a smaller value below a predetermined threshold may represent less data to be exchanged.

Further, a traffic indication may be transmitted directly between STAs 115, for example, being transmitted from STA 115-a and received at STA 115-b. In some cases, a traffic indication may be transmitted from a STA 115 to the AP 105. The traffic indication may include information relating to which STAs 115 have data to be exchanged. For example, the traffic indication may include an identifier of the transmitting STA 115 and/or the receiving STA 115.

The AP 105 may transmit traffic indications it receives or determines to other STAs 115, such as the receiving STA 115 which is scheduled to receive the traffic. In some cases, the AP 105 may prepare or determine a joint traffic indication. The joint traffic indication may be based on a number of traffic indications. For example, if STAs 115-a and 115-b are candidates to establish a direct connection 125, AP 105 may receive a first traffic indication from STA 115-a, which indicates the amount of traffic to be transmitted from STA 115-a and received at STA 115-b, and may receive a second traffic indication from STA 115-b, which indicates the amount of traffic to be transmitted from STA 115-b and received at STA 115-a. The AP 105 may use the first traffic indication and the second traffic indication, such as by adding the amount of traffic from the first traffic indication and the amount of traffic from the second traffic indication, to determine a joint traffic indication. The joint traffic indication may then be transmitted from the AP 105 to STA 115-a and/or STA 115-b in series or in parallel.

When a STA 115 evaluates a traffic indication, such as to determine whether to establish a direct connection, the STA 115 may check for the presence of data to be exchanged. For example, if traffic to be exchanged between the STAs is present, the STAs 115 may continue to establish a direct connection, whereas if there is an absence of traffic to be exchanged between STAs 115, the STAs may not establish a direct connection 125. In some cases, the STA 115 or an AP 105 (or both) may compare the traffic indication to a traffic threshold. In some cases, if the amount of traffic based on the traffic indication exceeds the threshold then the STA 115 may continue establishing a direct connection 125 with another STA 115. In other cases, if the amount of traffic does not exceed the threshold the STA 115 may not establish a direct connection with another STA 115.

If a STA 115 (or AP 105, or other network entity) determines that it would benefit the wireless communications system 200 due to increased or more-reliable communications to establish a direct connection between STAs 115, a direct connection 125 may be established. In some cases, at least one STA 115 involved with the direct connection 125 may remain associated with the AP 105, or may otherwise allow for continued communications with the AP 105, while communicating using the direct connection 125. For example, STAs 115-a and/or 115-b may remain associated with AP 105 after a direct connection 125 has been established between STA 115-a and STA 115-b. If the STAs 115-a and/or 115-b remain associated with the AP 105, at least one may more efficiently communicate with the AP 105 following a teardown of the direct connection 125. Similarly, in some cases, packets may still be exchanged with the AP 105 while the STAs 115 maintain the direct connection 125. In some cases, the direct connection 125 may be a device-to-device (D2D) connection. The direct connection 125 may be a TDLS connection. A TDLS connection may provide for streaming media or data between STAs 115, such as while connected to AP 105, without burdening the network as a whole.

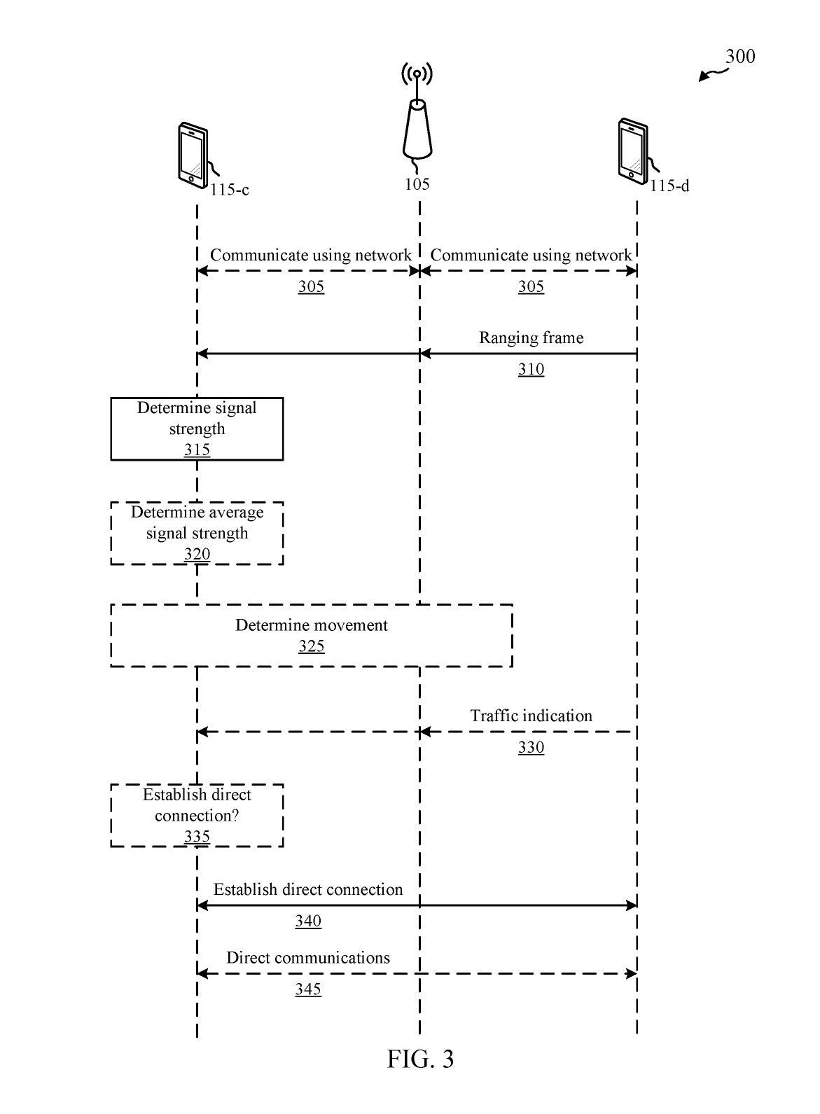

FIG. 3 illustrates an example of a process flow 300 for FTM protocol in establishing a TDLS connection. In some cases, process flow 300 may represent aspects of techniques performed by a STA 115, AP 105, or another network entity, as described with reference to FIGS. 1-2. Process flow 300 may include a first STA 115-c, an AP 105, and a second STA 115-d, which may be examples of a STA 115 or an AP 105 of FIGS. 1 and/or 2. It should be noted that dashed blocks, among others, may be considered optional in different examples.

At block 305, the first STA 115-c and/or the second STA 115-d may be associated with a first network of the AP 105. In some examples, the first network may be a WLAN network.

At block 310, the second STA 115-d may transmit a signal, such as a number of ranging frames. In some cases, the ranging frames may be FTM frames. The ranging frames may be transmitted from the second STA 115-d directly to the first STA 115-c, or to the AP 105. If the ranging frame is transmitted to the AP 105, the AP 105 may then transmit the ranging frame to the first STA 115-c. The ranging frame may be transmitted at a known transmit power and/or a known transmit rate. Similarly, if multiple ranging frames are transmitted from the second STA 115-d to be received at the first STA 115-c, at least some of the ranging frames (or all), may be transmitted using a same transmit power or a same rate.

In some examples, the ranging frames may be transmitted during a burst duration. In some cases, the burst duration may have a variable length. The length of the burst duration may be determined based on the number of ranging frames to be transmitted and/or the transmit rate of the ranging frames and/or a combination thereof. For example, four or more FTM frames may be transmitted during a burst duration of 4 ms or shorter.

It should be noted that in some cases ranging frames, such as FTM frames, may be a part of a query and a response message exchange. However, in some examples, it is not necessary for a query and a response to include exchanging ranging frames. At times, a ranging frame, such as an FTM frame, may be transmitted individually, or without request. In some cases, the query and response may be beneficial for ranging purposes because timestamps may be part of the message and a STA 115 may be able to determine a distance based on the time delays associated with propagation of the signal based on the timestamps and/or other information.

However, in some aspects of the current disclosure ranging frames, such as FTM frames, are used based on their defined transmission characteristics and may not be used for ranging purposes. As such, it may not be necessary to request a ranging frame, such as through a query and response protocol. Rather a ranging frame, such as an FTM frame, may be transmitted from a STA 115 to another STA 115 for the purpose of determining a signal strength and communication parameters rather than location or distance information. Further, at times the AP 105 is not involved in transmitting or receiving the ranging frames. The ranging frames, which in some examples may include FTM frames, may be transmitted directly from one STA 115 to another STA 115 without a query or request.

At block 315, the first STA 115-c may determine a signal strength. The signal strength may be a signal strength related to or based on the received ranging frames. The signal strength may be or include at least one RSSI value.

At block 320, the first STA 115-c may optionally determine an average signal strength. The average signal strength may be an average of a number of determined signal strengths, such as signal strengths relating to the received ranging frames. In some cases, the first STA 115-c may determine a separate average for each burst duration, if there are multiple burst durations present. The first STA 115-c may weigh the signal strengths of the received ranging frames. For example, in some cases, there may be a proportional weighting or an inverse proportional weighting of the received ranging frames. In some cases, the ranging frames may be weighted proportionally or inversely proportional to their arrival time. For example, the subsequent-arriving ranging frames may be weighted more (i.e., such as while calculating the signal strength), than the early-arriving ranging frames. This may be because, for example, the most recent ranging frames may include the most up-to-date perspective on the signal strength between the first STA 115-c and the second STA 115-d.

At block 325, the first STA 115-c and/or the AP 105 may determine movement, such as movement of a STA 115 relative to the AP 105, or movement of the first STA 115-c or the second STA 115-d with respect to the other STA 115 and/or another device. In some cases, movement of a STA 115-c may be determined based on a number of ranging frames. For example, if multiple ranging frames are transmitted from the second STA 115-d to the first STA 115-c and the signal strength is decreasing for each subsequent ranging frame, the first STA 115-c may determine that the first STA 115-c and the second STA 115-d are moving away from one another.

Similarly, if the signal strength of each subsequent ranging frame increases, the first STA 115-c may determine that its distance to the second STA 115-d is decreasing. The first STA 115-c may account for the relative motion between itself and the second STA 115-d when determining whether to establish a direct connection with the second STA 115-d. For example, if the signal strength is within a predetermined a threshold value for establishing a direct connection with the second STA 115-d and the first STA 115-c determines that it may be moving farther away from the second STA 115-d, it may prevent establishment of a direct connection (which otherwise would be established if the movement of the STAs 115 was not accounted for by the first STA 115-c).

At block 330, the second STA 115-d and/or the AP 105 may transmit a traffic indication to the first STA 115-c. The traffic indication may be used to determine whether there is traffic to be exchanged between the second STA 115-d and the first STA 115-c or whether to establish a direct connection between the first STA 115-c and the second STA 115-d. In some cases, the traffic indication may indicate the type or priority of the data to be exchanged.

At block 335, the first STA 115-c may determine whether to establish a direct connection with the second STA 115-d. The determination may be based on at least one signal strength, at least one traffic indication, motion of the first STA 115-c relative to the second STA 115-d, other factors discussed herein, other information or parameters, or a combination thereof.

At block 340, the first STA 115-c and the second STA 115-d may establish a direct connection between one another. In some examples, the direct connection may be a D2D connection. In some cases, the direct connection may be or include a TDLS connection. In some examples, it should be noted that block 335 and block 340 may be combined, may occur in series, or may at least partially overlap.

At block 345, the first STA 115-c and the second STA 115-d may communicate with one another using the direct connection. In some cases, the first STA 115-c and/or the second STA 115-d may additionally communicate with the AP 105.

In some examples, it should be noted that the AP 105 may or may not be present for at least one part (if not all) of the process. In some cases, the first STA 115-c and the second STA 115-d may exchange the necessary information and may establish a direct connection without the aid of or independent of an AP 105. Further, it should be noted that tearing down the direct connection may involve at least some similar steps as described in establishing the direct connection.

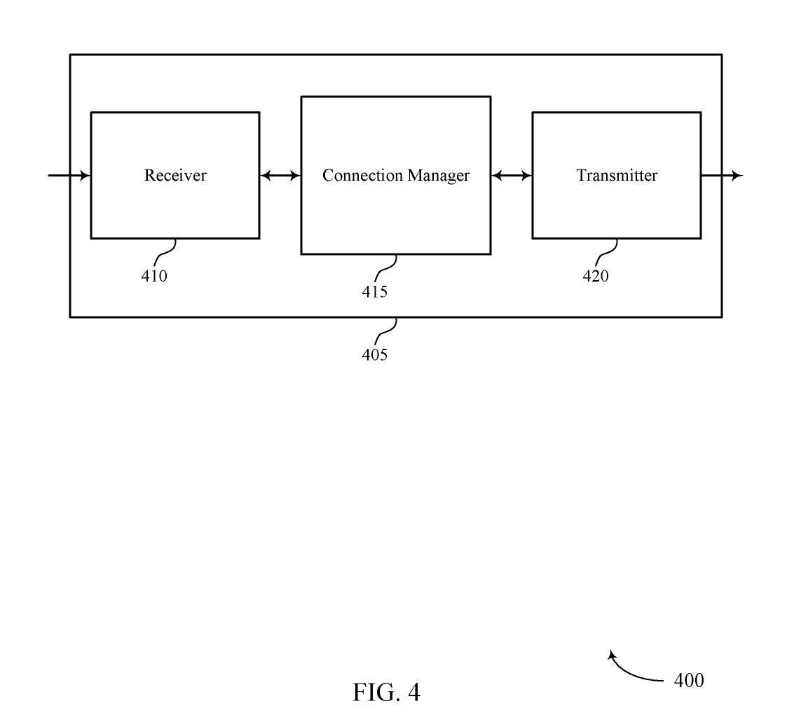

FIG. 4 shows a block diagram 400 of a wireless device 405 that supports FTM protocol in establishing a TDLS connection in accordance with various aspects of the present disclosure. Wireless device 405 may be an example of aspects of a STA 115 as described with reference to FIG. 1. Wireless device 405 may include receiver 410, connection manager 415, and transmitter 420. Wireless device 405 may also include a processor. Each of these components may be in communication with one another (e.g., via at least one bus).

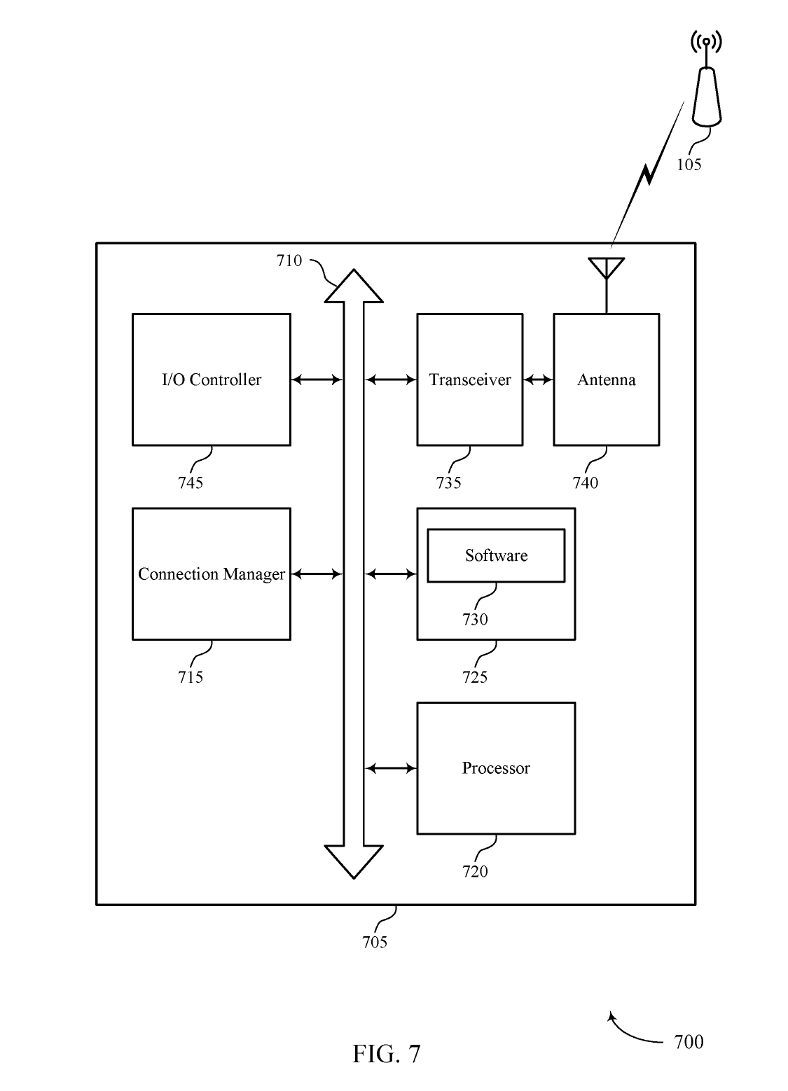

Receiver 410 may receive information such as packets, user data, or control information associated with various information channels (e.g., control channels, data channels, and information related to FTM protocol in establishing a TDLS connection, etc.). Information may be passed on to other components of the device. The receiver 410 may be an example of aspects of the transceiver 735 described with reference to FIG. 7.

Connection manager 415 may be an example of aspects of the connection manager 715 described with reference to FIG. 7.

Connection manager 415 may receive, at a first STA associated with a first network, ranging frames from a second STA associated with the first network, determine a signal strength based on the received ranging frames, and establish a direct connection between the first STA and the second STA based on the determined signal strength.

Transmitter 420 may transmit signals generated by other components of the device. In some examples, the transmitter 420 may be collocated with a receiver 410 in a transceiver module. For example, the transmitter 420 may be an example of aspects of the transceiver 735 described with reference to FIG. 7. The transmitter 420 may include a single antenna, or it may include a set of antennas.

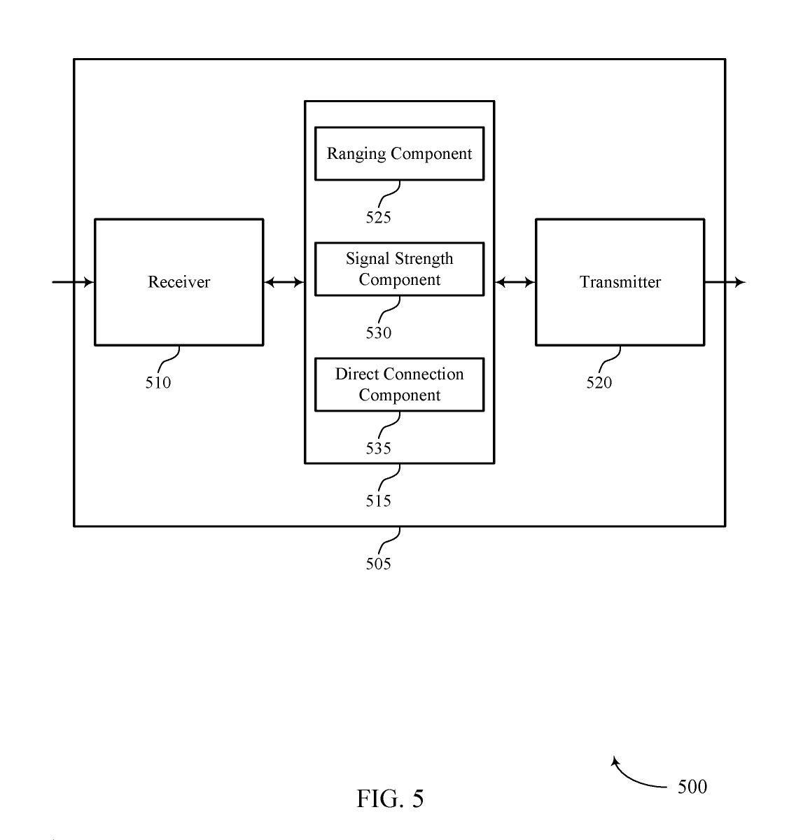

FIG. 5 shows a block diagram 500 of a wireless device 505 that supports FTM protocol in establishing a TDLS connection in accordance with various aspects of the present disclosure. Wireless device 505 may be an example of aspects of a wireless device 405 or a STA 115 as described with reference to FIGS. 1-4. Wireless device 505 may include receiver 510, connection manager 515, and transmitter 520. Wireless device 505 may also include a processor. Each of these components may be in communication with one another (e.g., via at least one bus).

Receiver 510 may receive information such as packets, user data, or control information associated with various information channels (e.g., control channels, data channels, and information related to FTM protocol in establishing a TDLS connection, etc.). Information may be passed on to other components of the device. The receiver 510 may be an example of aspects of the transceiver 735 described with reference to FIG. 7.

Connection manager 515 may be an example of aspects of the connection manager 715 described with reference to FIG. 7.

Connection manager 515 may also include ranging component 525, signal strength component 530, and direct connection component 535.

Ranging component 525 may receive, at a first STA associated with a first network, ranging frames from a second STA associated with the first network. In some cases, the ranging frames are transmitted using a same rate, or a same transmission power, or a combination thereof. In some cases, the ranging frames include FTM frames. In some cases, the FTM frames are transmitted during a burst duration having a variable length.

Signal strength component 530 may determine a signal strength based on the received ranging frames and determine that the second STA is in motion relative to the first STA based on the number of RSSI values. In some cases, the determined signal strength is based on a number of RSSI values. In some cases, determining the signal strength includes: determining an average of the number of RSSI values associated with the received ranging frames.

Direct connection component 535 may establish a direct connection between the first STA and the second STA based on the determined signal strength. In some cases, at least the first STA or the second STA or a combination thereof are associated with an AP on the first network while the direct connection is established. In some cases, the first network includes a WLAN. In some cases, the direct connection between the first STA and the second STA includes a TDLS.

Transmitter 520 may transmit signals generated by other components of the device. In some examples, the transmitter 520 may be collocated with a receiver 510 in a transceiver module. For example, the transmitter 520 may be an example of aspects of the transceiver 735 described with reference to FIG. 7. The transmitter 520 may include a single antenna, or it may include a set of antennas.

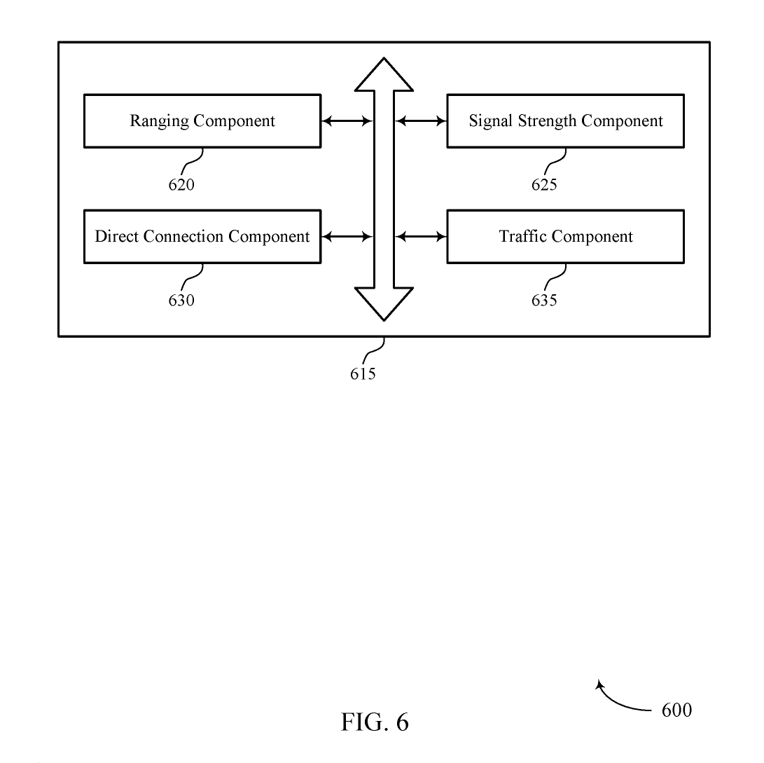

FIG. 6 shows a block diagram 600 of a connection manager 615 that supports FTM protocol in establishing a TDLS connection in accordance with various aspects of the present disclosure. The connection manager 615 may be an example of aspects of a connection manager 415, a connection manager 515, or a connection manager 715 described with reference to FIGS. 4, 5, and 7. The connection manager 615 may include ranging component 620, signal strength component 625, direct connection component 630, and traffic component 635. Each of these modules may communicate, directly or indirectly, with one another (e.g., via at least one bus).

Ranging component 620 may receive, at a first STA associated with a first network, ranging frames from a second STA associated with the first network. In some cases, the ranging frames are transmitted using a same rate, or a same transmission power, or a combination thereof. In some cases, the ranging frames include FTM frames. In some cases, the FTM frames are transmitted during a burst duration having a variable length.

Signal strength component 625 may determine a signal strength based on the received ranging frames and determine that the second STA is in motion relative to the first STA based on the number of RSSI values. In some cases, the determined signal strength is based on a number of received signal strength indicator (RSSI) values. In some cases, determining the signal strength includes: determining an average of the number of RSSI values associated with the received ranging frames.

Direct connection component 630 may establish a direct connection between the first STA and the second STA based on the determined signal strength. In some cases, at least the first STA or the second STA or a combination thereof are associated with an AP on the first network while the direct connection is established. In some cases, the first network includes a WLAN. In some cases, the direct connection between the first STA and the second STA includes a TDLS.

Traffic component 635 may receive, at the first STA, a traffic indication, where establishing the direct connection is based on the determined signal strength and the received traffic indication. In some cases, the traffic indication indicates a presence of data to be transmitted between the first STA and the second STA.

FIG. 7 shows a diagram of a system 700 including a device 705 that supports FTM protocol in establishing a TDLS connection in accordance with various aspects of the present disclosure. Device 705 may be an example of or include the components of wireless device 405, wireless device 505, or a STA 115 as described above, e.g., with reference to FIGS. 1-5. Device 705 may include components for bi-directional voice and data communications including components for transmitting and receiving communications, including connection manager 715, processor 720, memory 725, software 730, transceiver 735, antenna 740, and I/O controller 745. These components may be in electronic communication via at least one bus (e.g., bus 710).

Processor 720 may include an intelligent hardware device, (e.g., a general-purpose processor, a digital signal processor (DSP), a central processing unit (CPU), a microcontroller, an application specific integrated circuit (ASIC), a field-programmable gate array (FPGA), a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting FTM protocol in establishing a TDLS connection).720.

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a Basic Input-Output system (BIOS) which may control basic hardware and/or software operation such as the interaction with peripheral components or devices.

Software 730 may include code to implement aspects of the present disclosure, including code to support FTM protocol in establishing a TDLS connection. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via at least one antenna, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device may include a single antenna 740. However, in some cases the device may have more than one antenna 740, which may be capable of concurrently transmitting or receiving multiple wireless transmissions.

I/O controller 745 may manage input and output signals for device 705. I/O controller 745 may also manage peripherals not integrated into device 705. In some cases, I/O controller 745 may represent a physical connection or port to an external peripheral. In some cases, I/O controller 745 may utilize an operating system such as iOS®, ANDROID®, MS-DOS®, MS-WINDOWS®, OS/2®, UNIX®, LINUX®, or another known operating system.

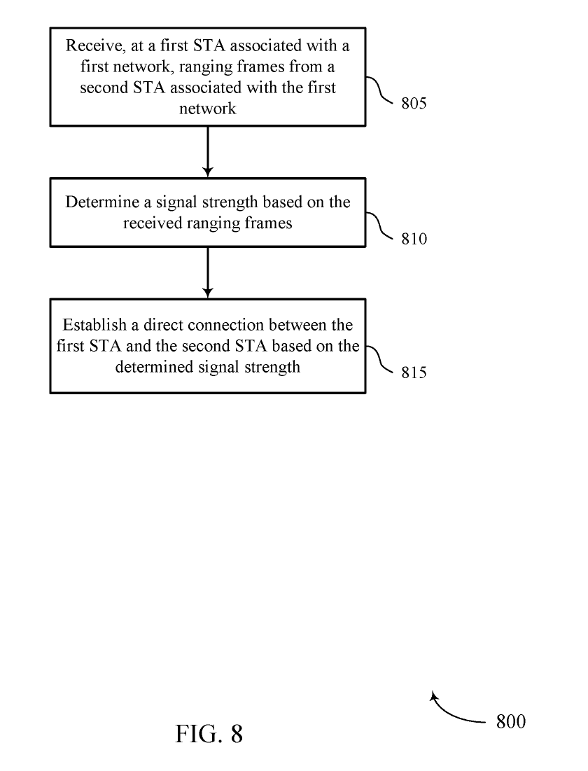

FIG. 8 shows a flowchart illustrating a method 800 for FTM protocol in establishing a TDLS connection in accordance with various aspects of the present disclosure. The operations of method 800 may be implemented by a STA 115 or its components as described herein. For example, the operations of method 800 may be performed by a connection manager 415, 515, 615, or 715 as described with reference to FIGS. 4 through 7. In some examples, a STA 115 may execute a set of codes to control the functional elements of the device to perform the functions described below. Additionally or alternatively, the STA 115 may perform aspects the functions described below using special-purpose hardware.

At block 805 the STA 115 may receive, at a first station (STA) associated with a first network, ranging frames from a second STA associated with the first network. The operations of block 805 may be performed according to the methods described with reference to FIGS. 1 through 3. In certain examples, aspects of the operations of block 805 may be performed by a ranging component 525 or 620 as described with reference to FIGS. 4 through 7.

At block 810 the STA 115 may determine a signal strength based at least in part on the received ranging frames. The operations of block 810 may be performed according to the methods described with reference to FIGS. 1 through 3. In certain examples, aspects of the operations of block 810 may be performed by a signal strength component 530 or 625 as described with reference to FIGS. 4 through 7.

At block 815 the STA 115 may establish a direct connection between the first STA and the second STA based at least in part on the determined signal strength. The operations of block 815 may be performed according to the methods described with reference to FIGS. 1 through 3. In certain examples, aspects of the operations of block 815 may be performed by a direct connection component 535 or 630 as described with reference to FIGS. 4 through 7.

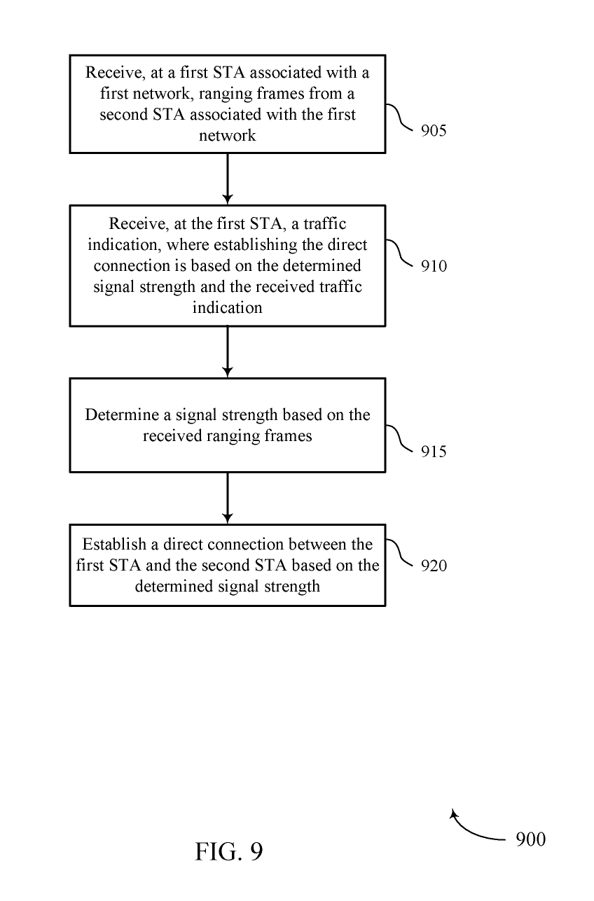

FIG. 9 shows a flowchart illustrating a method 900 for FTM protocol in establishing a TDLS connection in accordance with various aspects of the present disclosure. The operations of method 900 may be implemented by a STA 115 or its components as described herein. For example, the operations of method 900 may be performed by a connection manager 415, 515, 615, or 715 as described with reference to FIGS. 4 through 7. In some examples, a STA 115 may execute a set of codes to control the functional elements of the device to perform the functions described below. Additionally or alternatively, the STA 115 may perform aspects the functions described below using special-purpose hardware.

At block 905 the STA 115 may receive, at a first station (STA) associated with a first network, ranging frames from a second STA associated with the first network. The operations of block 905 may be performed according to the methods described with reference to FIGS. 1 through 3. In certain examples, aspects of the operations of block 905 may be performed by a ranging component 525 or 620 as described with reference to FIGS. 4 through 7.

At block 910 the STA 115 may receive, at the first STA, a traffic indication, wherein establishing the direct connection is based at least in part on the determined signal strength and the received traffic indication. The operations of block 920 may be performed according to the methods described with reference to FIGS. 1 through 3. In certain examples, aspects of the operations of block 920 may be performed by a traffic component 635 as described with reference to FIGS. 4 through 7.

At block 915 the STA 115 may determine a signal strength based at least in part on the received ranging frames. The operations of block 910 may be performed according to the methods described with reference to FIGS. 1 through 3. In certain examples, aspects of the operations of block 910 may be performed by a signal strength component 530 or 625 as described with reference to FIGS. 4 through 7.

At block 920 the STA 115 may establish a direct connection between the first STA and the second STA based at least in part on the determined signal strength. The operations of block 915 may be performed according to the methods described with reference to FIGS. 1 through 3. In certain examples, aspects of the operations of block 915 may be performed by a direct connection component 535 or 630 as described with reference to FIGS. 4 through 7.

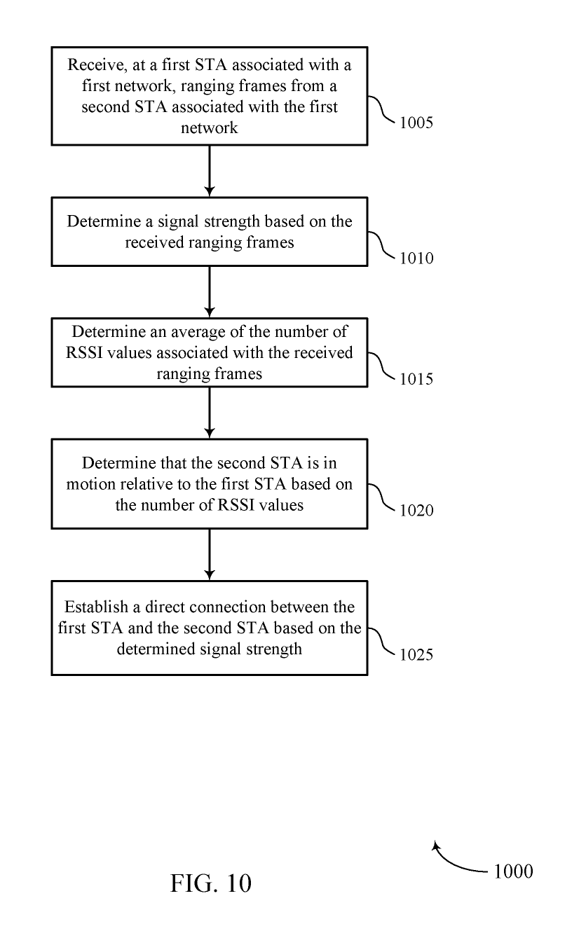

FIG. 10 shows a flowchart illustrating a method 1000 for FTM protocol in establishing a TDLS connection in accordance with various aspects of the present disclosure. The operations of method 1000 may be implemented by a STA 115 or its components as described herein. For example, the operations of method 1000 may be performed by a connection manager 415, 515, 615, or 715 as described with reference to FIGS. 4 through 7. In some examples, a STA 115 may execute a set of codes to control the functional elements of the device to perform the functions described below. Additionally or alternatively, the STA 115 may perform aspects the functions described below using special-purpose hardware.

At block 1005 the STA 115 may receive, at a first station (STA) associated with a first network, ranging frames from a second STA associated with the first network. The operations of block 1005 may be performed according to the methods described with reference to FIGS. 1 through 3. In certain examples, aspects of the operations of block 1005 may be performed by a ranging component 525 or 620 as described with reference to FIGS. 4 through 7.

At block 1010 the STA 115 may determine a signal strength based at least in part on the received ranging frames. The operations of block 1010 may be performed according to the methods described with reference to FIGS. 1 through 3. In certain examples, aspects of the operations of block 1010 may be performed by a signal strength component 530 or 625 as described with reference to FIGS. 4 through 7.

At block 1015 the STA 115 may determine an average of the number of RSSI values associated with the received ranging frames. The operations of block 1015 may be performed according to the methods described with reference to FIGS. 1 through 3. In certain examples, aspects of the operations of block 1015 may be performed by a signal strength component 530 or 625 as described with reference to FIGS. 4 through 7.

At block 1020 the STA 115 may determine that the second STA is in motion relative to the first STA based at least in part on the number of RSSI values. The operations of block 1020 may be performed according to the methods described with reference to FIGS. 1 through 3. In certain examples, aspects of the operations of block 1020 may be performed by a signal strength component 530 or 625 as described with reference to FIGS. 4 through 7.

At block 1025 the STA 115 may establish a direct connection between the first STA and the second STA based at least in part on the determined signal strength. The operations of block 1025 may be performed according to the methods described with reference to FIGS. 1 through 3. In certain examples, aspects of the operations of block 1025 may be performed by a direct connection component 535 or 630 as described with reference to FIGS. 4 through 7.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include at least one carrier, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, at least one microprocessor in conjunction with a DSP core, or any other such configuration).

The functions described herein may be implemented in hardware, software executed by a processor, firmware, or any combination thereof. If implemented in software executed by a processor, the functions may be stored on or transmitted over as at least one instruction or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless communication, comprising:
receiving, at a first station (STA) associated with a first network, ranging frames from a second STA associated with the first network;
determining a signal strength based at least in part on the received ranging frames; and
establishing a direct connection between the first STA and the second STA based at least in part on the determined signal strength.

2. The method of claim 1, further comprising:
receiving, at the first STA, a traffic indication, wherein establishing the direct connection is based at least in part on the determined signal strength and the received traffic indication.

3. The method of claim 2, wherein the traffic indication indicates a presence of data to be transmitted between the first STA and the second STA.

4. The method of claim 1, wherein at least the first STA or the second STA or a combination thereof are associated with an access point (AP) on the first network while the direct connection is established.

5. The method of claim 1, wherein the ranging frames are transmitted using a same rate, or a same transmission power, or a combination thereof.

6. The method of claim 1, wherein the determined signal strength is based at least in part on a number of received signal strength indicator (RSSI) values.

7. The method of claim 6, wherein determining the signal strength comprises:
determining an average of the number of RSSI values associated with the received ranging frames.

8. The method of claim 6, further comprising:
determining that the second STA is in motion relative to the first STA based at least in part on the number of RSSI values.

9. The method of claim 1, wherein the ranging frames comprise:
fine timing measurement (FTM) frames.

10. The method of claim 9, wherein the FTM frames are transmitted during a burst duration having a variable length.

11. The method of claim 1, wherein the first network comprises a wireless local area network (WLAN).

12. The method of claim 1, wherein the direct connection between the first STA and the second STA comprises a tunneled direct link setup (TDLS).

13. An apparatus for wireless communication, comprising:
means for receiving, at a first station (STA) associated with a first network, ranging frames from a second STA associated with the first network;
means for determining a signal strength based at least in part on the received ranging frames; and
means for establishing a direct connection between the first STA and the second STA based at least in part on the determined signal strength.

14. An apparatus for wireless communication, in a system comprising:
a processor;
memory in electronic communication with the processor; and
instructions stored in the memory and operable, when executed by the processor, to cause the apparatus to:
receive, at a first station (STA) associated with a first network, ranging frames from a second STA associated with the first network;
determine a signal strength based at least in part on the received ranging frames; and
establish a direct connection between the first STA and the second STA based at least in part on the determined signal strength.

15. The apparatus of claim 14, wherein the instructions are further executable by the processor to:
receive, at the first STA, a traffic indication, wherein establishing the direct connection is based at least in part on the determined signal strength and the received traffic indication.

16. The apparatus of claim 14, wherein at least the first STA or the second STA or a combination thereof are associated with an access point (AP) on the first network while the direct connection is established.

17. The apparatus of claim 14, wherein the ranging frames are transmitted using a same rate, or a same transmission power, or a combination thereof.

18. The apparatus of claim 14, wherein the determined signal strength is based at least in part on a number of received signal strength indicator (RSSI) values.

19. The apparatus of claim 18, wherein determining the signal strength comprises:
determining an average of the number of RSSI values associated with the received ranging frames.

20. The apparatus of claim 18, wherein the instructions are further executable by the processor to:
determine that the second STA is in motion relative to the first STA based at least in part on the number of RSSI values.
